(19) United States
(12) Patent Application Publication
(10) Pub. No.: US 2016/0176137 A1
(43) Pub. Date: Jun. 23, 2016

(54) TIRE BUILDING DRUM AND ASSEMBLY/DISASSEMBLY APPARATUS THEREOF

(71) Applicant: HANKOOK TIRE CO., LTD., Seoul (KR)

(72) Inventor: Cheol JEON, Daejeon (KR)

(21) Appl. No.: 14/815,902

(22) Filed: Jul. 31, 2015

(30) Foreign Application Priority Data
Nov. 13, 2014 (KR) 10-2014-0157791

(51) Int. Cl. B29D 30/12

(52) U.S. Cl. CPC B29D 30/12; B29D 2030/105

(57) ABSTRACT

Tire building drum and assembly/disassembly apparatus of tire building drum. The tire building drum includes upper holder with drum shaft, several drum segments installed according to circumference of the upper holder, the lower holder fixed into the upper holder and drum segments, and means for locking the connecting part of drum segment between the upper holder and the lower holder; the assembly/disassembly apparatus of tire building drum includes the rotary plate spinning the lower holder of tire building drum, drum segment supporting pin, and tire supporting plate, and while the rotary plate is operated with being connected to clamp cylinder and location adjustment cylinder through shaft and link, it rotates the lower holder in clockwise and counterclockwise direction through a combination of key of the lower holder and key way of the rotary plate, thereby locking or unlocking clamp block of the upper and lower holder.

### FIELD

The present invention relates to a tire building drum and an assembly/disassembly apparatus thereof which improve capacity ratio by simplifying the process of building drum disassembly/assembly and minimizing abnormality of assembly function and examination, especially through simplified structure.

### BACKGROUND

Tire is produced by refining process of making compounds through mixing raw materials, building process of forming the compounds into components like belts through rolling/pressing/cutting and forming a green tire by attaching the components in tire building drum in consecutive order, and vulcanizing process of putting green tire formed in the building process into a vulcanizer.

In this tire production process, the disassembly/assembly apparatus has been used so as to separate the finished tire produced through the building drum and the vulcanizer from the building drum, but operation trouble takes place in assembly/disassembly operation of building drum due to complexity of assembly structure. For example, if the length of pin supporting drum segment of building drum is long, disassembly/assembly process has not been carried out due to contact between pin and segment and between pin and lower holder during disassembly of an upper holder of the building drum from the disassembly/assembly apparatus.

And, there were frequent problems such as abnormality of function and frequent replacement, caused by aging of machine parts assembling the upper and lower holder of the building drum.

### DISCLOSURE OF RELATED ART DOCUMENTS

Korean Laid-open No. 10-2009-0125921 (Dec. 8, 2009)

The present invention is to solve the aforementioned problems. The present invention is to promote simplification of structure of the building drum and to minimize abnormality of assembly function and examination, thereby aiming to provide a tire building drum and assembly/disassembly apparatus thereof improving capacity ratio and minimizing a number of mechanical elements.

Tire building drum in the present invention aiming to achieve the above object includes an upper holder with drum shaft, several drum segments installed along circumference of the upper holder, a lower holder fixed into the upper holder and drum segments, and means for locking a connecting part of the drum segments between the upper holder and the lower holder.

Further, an assembly/disassembly apparatus of the tire building drum comprises a rotary plate spinning the lower holder of building drum, drum segment supporting plate ascending and descending through up-down cylinder and a tire supporting plate.

The present invention minimizes a number of mechanical elements of the building drum, reduces abnormality of assembly function caused by aging of components, and improves tire production automation since abnormality of assembly function can be removed and examination of the building drum may be more easily carried out.

### BRIEF DESCRIPTION OF THE DRAWINGS

FIG. 1 is a cross section of disassembled tire building drum according to an embodiment of the present invention,

FIG. 2 is a side elevation of the assembly/disassembly apparatus of the tire building drum according to an embodiment of the present invention,

FIG. 3A shows the process of unlocking of the lower disassembling tire building drum from the assembly/disassembly apparatus of the tire building drum according to an embodiment of the present invention,

FIG. 3B shows the process of disassembly of the upper disassembling tire building drum from the assembly/disassembly apparatus of the tire building drum according to an embodiment of the present invention,

FIG. 3C shows the process of ascending of supporting pin of drum segment from the assembly/disassembly apparatus of the tire building drum according to an embodiment of the present invention,

FIG. 3D shows the process of disassembly of individual drum segment from the assembly/disassembly apparatus of the tire building drum according to an embodiment of the present invention,

FIG. 3E shows the process of disassembly of individual drum segment from the assembly/disassembly apparatus of the tire building drum according to an embodiment of the present invention,

FIG. 4A shows the input location of building drum of the locking/unlocking states of the lower holder of the tire building drum according to an embodiment of the present invention,

FIG. 4B shows the unlocking operation of the lower holder of the locking/unlocking states of the lower holder of the tire building drum according to an embodiment of the present invention,

FIG. 4C shows the locking operation of the lower holder of the locking/unlocking states of the lower holder of the tire building drum according to an embodiment of the present invention,

FIG. 4D shows the withdrawable location of building drum of the locking/unlocking states of the lower holder of the tire building drum according to an embodiment of the present invention,

FIG. 5 is a flow chart illustrating each drum segment being disassembled from the finished tire.

### DETAILED DESCRIPTION

The embodiments of the present invention are described in detail hereafter by reference to the accompanying drawings.

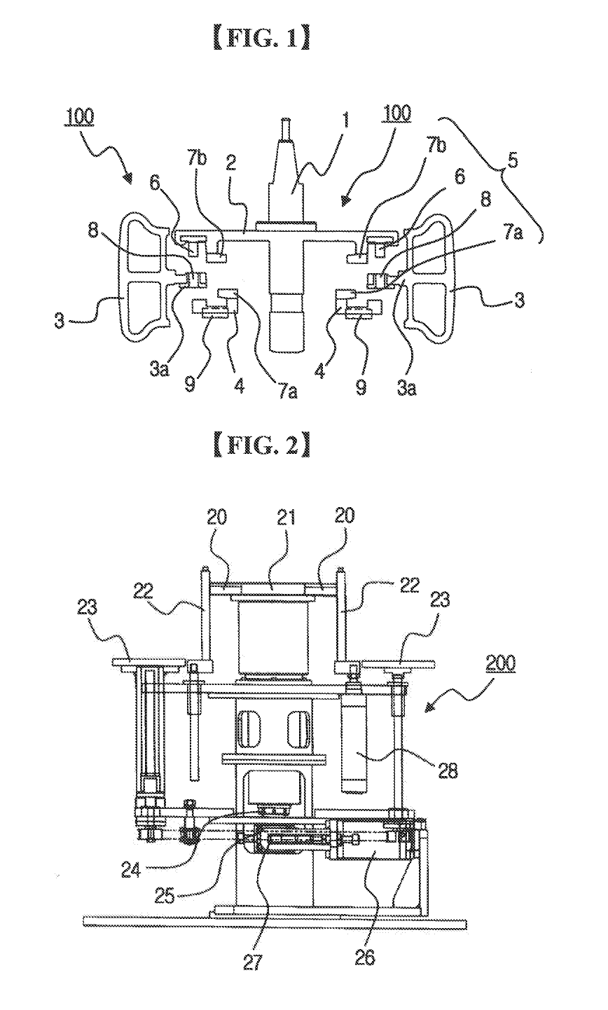

FIG. 1 is a cross section of disassembled tire building drum according to an embodiment of the present invention.

Tire building drum (100) includes an upper holder (2) with drum shaft (1), several drum segments (3) Installed along circumference of the upper holder (2), a lower holder (4) fixed into the upper holder (2) and the drum segments (3), and means (5) for locking a connecting part (3a) of the drum segments (3) between the upper holder and the lower holder (2, 4).

The upper holder (2) includes drum shaft (1), location determination pins (6) and clamp blocks (7b) to be assembled into the lower holder (4), while the drum shaft (1) has a function of being fixed into gripper and chuck and supports rotation of the building drum (100) in the tire production process.

The location determination pins (6) of means for locking (5) are detachably engaged with coupling holes (8) in the connecting part (3a) of the drum segments (3) in order to lock and keep location of drum segment (3) into the building drum (100). If the lower holder (4) rotates and the clamp block (7a) of the lower holder (4) engages with corresponding clamp block (7b) of means for locking (5) provided at the upper holder (2), unlocking of the upper and lower holder (2, 4) and several drum segments (3) is prevented by the engagement.

The horizontal tilt angle of the respective clamp block (7a, 7b) of the upper holder (2) and the lower holder (4) is desirable to be between 1 and 3 degrees. According to the tilt angle, vertical direction force is applied onto the slope by the engagement in proportion to locking force. In this case, it is usual the force for unlocking clamp block (7a, 7b) is smaller than the force for locking, but the former may be bigger if the upper holder (2) and the lower holder (4) expand in the vulcanizing process of tire.

Therefore, locking force of the clamp block (7a, 7b) is determined by the magnitude of force to unlock the clamp block (7a, 7b) through one cycle of tire production process.

Meanwhile, the lower holder (4) is assembled with the upper holder (2) by means of the respective clamp block (7a, 7b) of the lower and upper holder (4, 2), thereby being contact with the underside of the connecting part (3a) of drum segments (3) and preventing movement of the drum segments (3).

If rotary power of rotary plate (21) of the assembly/disassembly apparatus of tire building drum (200) is transmitted, the lower holder (4) rotates toward clockwise or counterclockwise direction, thereby engaging or disengaging the corresponding clamp block (7a) engaged with clamp block (7b) of the upper holder since the key (9) of the lower holder (4) is combined with key way (20) of the assembly/disassembly apparatus (200) of tire building drum (100), to be described later.

Regarding the tire building drum (100), green tire (not shown in drawing) is produced through the drum segment (3) installed along the outer circumference surface of the tire building drum (100) in the process of tire building, and the green tire along with the tire building drum (100) of the present invention is put into vulcanizing mold of vulcanizer and is vulcanized, thereby producing finished tire.

The finished tire is disassembled from the tire building drum (100) by assembly/disassembly apparatus (200) of the tire building drum (100), to be disclosed in the following.

Referring to FIG. 2, below is an explanation of the assembly/disassembly apparatus (200) of the tire building drum (100) according to an embodiment of the present invention.

The assembly/disassembly apparatus (200) of the tire building drum (100) according to an embodiment of the present invention comprises rotary plate (21) spinning the lower holder (4) of the tire building drum (100), drum segment supporting pin (22), and tire supporting plate (23). And while the rotary plate (21) is operated with being connected to a clamp cylinder (26) and a location adjustment cylinder (27) through a shaft (24) and link (25), it rotates the lower holder (4) in clockwise or counterclockwise direction through a combination of key (9) of the lower holder (4) and key way (20) of rotary plate (21), thereby locking or unlocking clamp block (7a, 7b) of the upper and lower holder (2, 4).

The drum segment supporting pin (22) is established to remove interference in the disassembly process of drum segment (3), which is supporting the overall tire building drum (100) or descending individually by ascending and descending through up-down cylinder (28).

Also, the tire supporting plate (23) has a function of supporting tire (300) when each drum segment (3) of the tire building drum (100) is disassembled from the inside of tire (300).

In the mean time, the rotary plate (21) is assembled into shaft (24) and rotates in clockwise or counterclockwise direction according to push or pull of link (25) fixed into the shaft (24) by clamp cylinder (26). In this case, locking force and operation speed are determined by adjusting speed controller of pressure and air inlet of the clamp cylinder (26).

Meanwhile, instead of the mechanism moving link (25) connected to the shaft (24), pinion gear may be installed in shaft (24) as necessary, and rotary plate (21) may be rotated by making rack gear engage with pinion gear.

And motor may be installed instead of the clamp cylinder (26), and in this case, the lower holder (4) can be assembled with steady force by torque control.

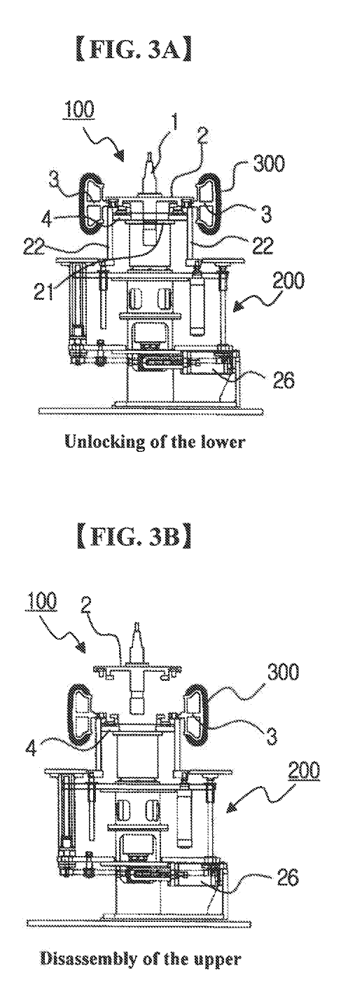

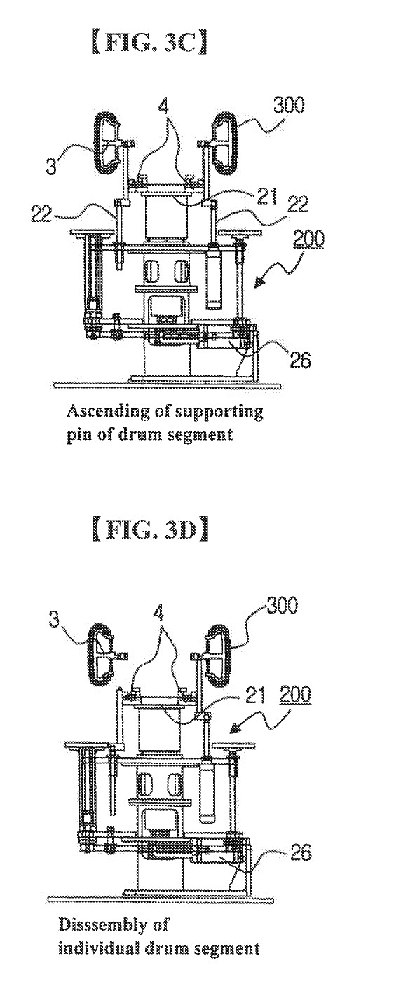

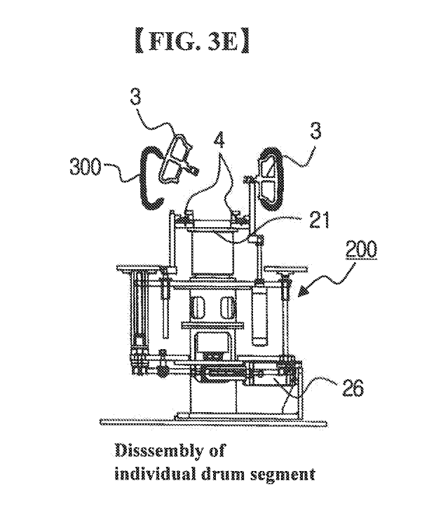

Referring to FIGS. 3A-E and 5, below is an explanation of disassembly operation of the tire building drum (100) using the assembly/disassembly apparatus (200) of the tire building drum (100).

First of all, the process of building green tire is completed in the drum segments (3) of the tire building drum (100), and the green tire along with the tire building drum (100) is put into vulcanizing mold of vulcanizer and is vulcanized.

And then, the tire building drum (100), to which the finished tire (300) after vulcanization is attached, is put into the assembly/disassembly apparatus (200) of tire building drum (100), as illustrated in FIG. 2.

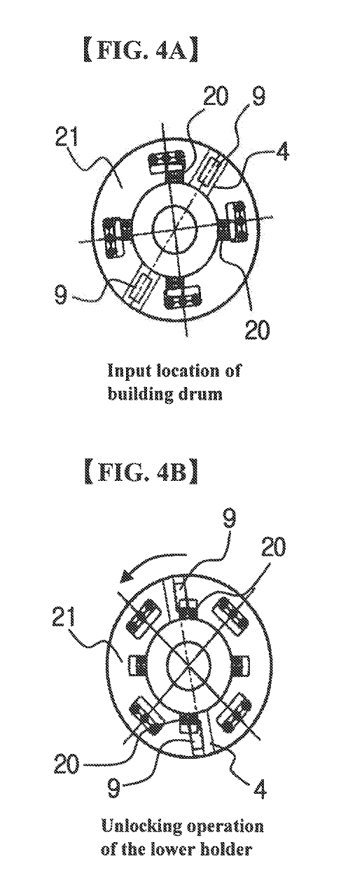

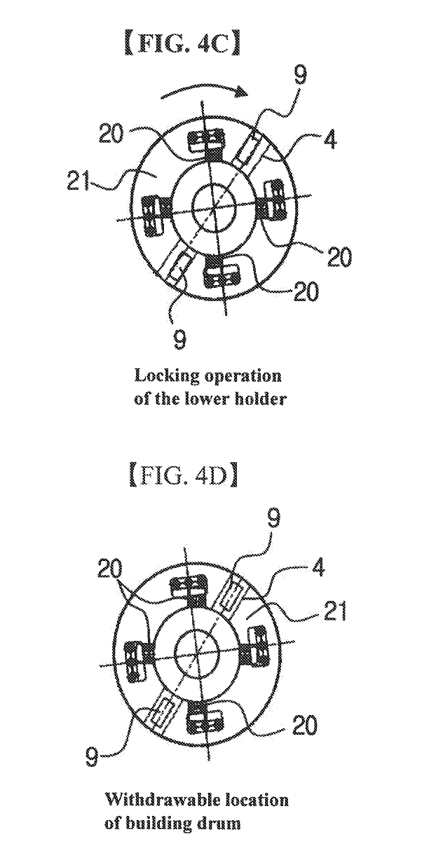

The rotary plate (21) of the assembly/disassembly apparatus (200) of the tire building drum (100), as illustrated in FIG. 4A, should have been rotated into the location in which key (9) of the lower holder (4) and key way (20) of the rotary plate (21) may be combined.

If the input of the tire building drum (100) is completed, the rotary plate (21), as illustrated in FIG. 4B, rotates toward arrow in counterclockwise direction, thereby disassembling the lower holder (4) from the upper holder (2) of the tire building drum (100) into an unlocked condition [refer to FIG. 3A].

If the lower holder (4) is disassembled in rotary plate (21) of the assembly/disassembly apparatus (200) of tire building drum (100) as shown in FIG. 4B, the upper holder (2) is disassembled toward vertical direction from the tire building drum (100) by the use of drum shaft gripper, and the disassembled upper holder (2) is moved into storage box and stored as illustrated in FIG. 3B.

As disclosed in FIG. 3B, the upper holder (2) is disassembled from the tire building drum (100), and the whole part of drum segment supporting pin (22) is elevated in order to disassemble drum segments (3).

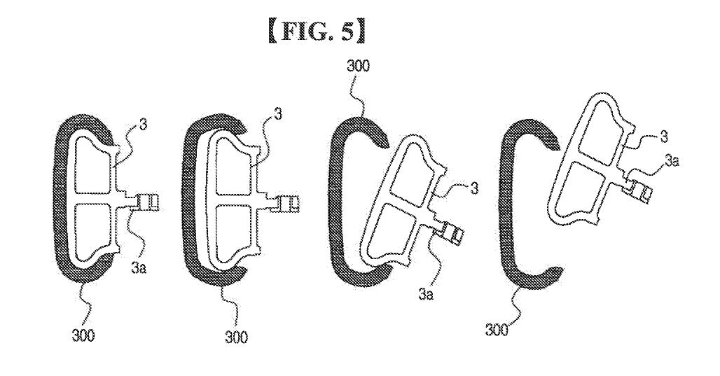

And after locking each drum segment (3) using drum segment gripper, the drum segment (3) is disassembled from the inside of finished tire (300) as shown in FIG. 5. In this case, as disclosed in FIGS. 3D and 3E, the drum segment gripper removes movement interference by descending each drum segment supporting pin (22) before the drum segment gripper fixes and carries out disassembly operation of the drum segment (3).

And as shown in FIGS. 3E and 5, each drum segment (3) disassembled from finished tire (300) moves to another segment storage box, and the drum segments (3) are all disassembled from finished tire (300), thereby the finished tire (300) is released out.

Meanwhile, after disassembly of tire building drum (100) is completed using the assembly/disassembly apparatus (200) of tire building drum (100), assembly of tire building drum (100) is carried out in reverse order of the aforementioned disassembly operation.

In other words, after ascending the overall construction of descended drum segment supporting pin (22), each drum segment (3) is moved into the assembly/disassembly apparatus (200) of tire building drum (100) from the drum segment storage box, and the overall construction of the drum segments (3) safely rests on the drum segment supporting pin (22), and the drum segment supporting pin (22) is descended and then the upper holder (2) stored in storage box is moved and combined with the drum segment (3).

After that, as illustrated in FIG. 4C, the assembly process of the tire building drum (100) is completed, when the lower holder (4) rotates toward clockwise direction and is locked in rotary plate (21) of the assembly/disassembly apparatus (200) of tire building drum (100).

Thus, location adjustment cylinder (27) of the assembly/disassembly apparatus (200) of tire building drum (100) is operated, thereby the tire building drum (100) assembled with the rotary plate (21) rotated as disclosed in FIG. 4D.

In this case, before the operation of the location adjustment cylinder (27), air in clamp cylinder (26) should be emitted, thereby any force should not be applied on the rotary plate (21).

Thus, the assembly/disassembly apparatus (200) of tire building drum (100) enables a series of automation processes of disassembling the tire building drum (100), vulcanizing the outside of the tire building drum (100), thereby disassembling finished tire (300).

Tire building drum and assembly/disassembly apparatus thereof according to an embodiment of the present invention discloses the process of vulcanizing tire building drum producing green tire and green tire in vulcanizing mold and assembling for disassembly and reworking in order to take finished tire out of tire building drum through the assembly/disassembly apparatus of tire building drum, but the present invention is not confined to a specific example, and various forms may be achieved within technical categories and ideas of the present invention.

Scope of protection in the present invention is not confined to a specific example, and various modifications may be achieved within drawings and claims of the present invention.

### EXPLANATION OF MARKS

| | |
|---|---|
| 1: Drum shaft, | 2: Upper bolder, |
| 3: Drum segment, | 4: Lower holder, |
| 5: Means for locking, | 6: Location determination pin, |
| 7a, 7b: Clamp block, | 8: Coupling hole, |
| 9: Key, | |
| 20: Key way, | 21: Rotary plate, |
| 22: Drum segment supporting pin, | 23: Tire supporting plate, |
| 24: Shaft, | 25: Link, |
| 26: Clamp cylinder, | 27: Location adjustment cylinder, |
| 28: Up-down cylinder, | |
| 100: Tire building drum, | |

200: Assembly/disassembly apparatus of tire building drum,

300: Tire.

1. A tire building drum producing and building green tire, comprising an upper holder with drum shaft, several drum segments installed along the circumference of the upper holder, a lower holder fixed into the upper holder and drum segments, and means for locking a connecting part of drum segments between the upper holder and the lower holder.

2. The tire building drum according to claim 1, wherein the upper holder further comprises drum shaft, location determination pins and clamp block, provided at the lower holder.

3. The tire building drum according to claim 1, wherein the location determination pins of means for locking is detachably engaged with coupling holes in the connecting part of the drum segments in order to lock and keep location of drum segments into the building drum, and the lower holder rotates and then the corresponding clamp block of the lower holder engages with corresponding clamp block of means for locking provided at the upper holder, unlocking of the upper and lower holder and several drum segments is prevented by the engagement.

4. The tire building drum according to claim 3, wherein the horizontal tilt angle of clamp block of the upper holder and the lower holder is between 1 and 3 degrees.

5. The tire building drum according to claim 1, wherein the lower holder is assembled with the upper holder by means of the clamp block of the lower and upper holder, thereby being contact with the underside of the connecting part of drum segments and preventing movement of the drum segments.

6. The tire building drum according to claim 1, wherein key of the lower holder is detachably engaged with key way of the assembly/disassembly apparatus of tire building drum.

7. An assembly/disassembly apparatus of tire building drum, comprising rotary plate spinning the lower holder of tire building drum, drum segment supporting pin and tire supporting plate, and wherein the rotary plate is connected to clamp cylinder and location adjustment cylinder through the shaft and link, and the rotary plate rotates the lower holder toward clockwise and counterclockwise direction through a combination of key of the lower holder and key way of rotary plate, thereby locking or unlocking clamp block of the upper and lower holder.

8. The assembly/disassembly apparatus of tire building drum according to claim 7, wherein the drum segment supporting pin is established to remove interference in the disassembly process of drum segment, which is supporting the overall tire building drum or descending individually by ascending and descending through up-down cylinder.

9. The assembly/disassembly apparatus of tire building drum according to claim 7, wherein the tire supporting plate has a function of supporting tire when each drum segment of tire building drum is disassembled from the inside of tire.

10. The assembly/disassembly apparatus of tire building drum according to claim 7, wherein the rotary plate, assembled into the shaft, rotates in clockwise or counterclockwise direction according to push or pull of link, fixed into the shaft, by clamp cylinder.
